(19) United States
(12) Patent Application Publication
(10) Pub. No.: US 2026/0227319 A1
(43) Pub. Date: Aug. 6, 2026

(54) ENVIRONMENTAL TEST DEVICE

(71) Applicant: ESPEC CORP., Osaka-shi (JP)

(72) Inventors: Haruka MINATO, Osaka-shi (JP); Shiori BOKUI, Osaka-shi (JP); Shunsuke OKADA, Osaka-shi (JP)

(73) Assignee: ESPEC CORP., Osaka-shi (JP)

(21) Appl. No.: 19/465,917

(22) Filed: Jan. 30, 2026

(30) Foreign Application Priority Data
Feb. 5, 2025 (JP) 2025-017705

(51) Int. Cl. G01N 17/00

(52) U.S. Cl. CPC G01N 17/002

(57) ABSTRACT

An environmental test device includes: a test chamber having an opening and including a test space defined in the test chamber; a placement surface located in the test chamber such that a specimen is placed; and a panel located in the test chamber such that terminals electrically connected to the specimen are located. The panel rotates about a rotation axis between a test position at which the specimen is tested and a work position at which work is performed on the terminals to thereby change a relative positional relationship between the panel and the placement surface.

### CROSS-REFERENCE TO RELATED APPLICATION

This application claims the benefit of priority to Japanese Patent No. 2025-17705 filed on Feb. 5, 2025. The entire contents of this application are hereby incorporated herein by reference. The entire contents including the specification, drawings, and claims disclosed in the Japanese application are incorporated herein by reference.

### FIELD

The technique disclosed here relates to an environmental test device.

### BACKGROUND

Japanese Utility Model Application Laid-Open No. 63-190976 discloses a thermostat bath for performing a high-temperature operating test on ICs. The thermostat bath includes a body, a door attached to the front surface of the body, and a specimen connector panel fixed to the inner side of the door and loaded with specimen ICs. The specimen ICs receive a test voltage via a test connector fixed to the inner side of the door.

### SUMMARY

The connector includes a terminal, and a specimen is connected to the terminal via a wire. The user needs to connect the wire connected to the specimen to the corresponding terminal before the start of a test. If workability is poor, there is a risk that the wire may be connected to a wrong terminal or that the work time may be prolonged. In particular, in the case of a large number of terminals, it is important to enhance workability.

It is therefore an object of the technique disclosed here to enhance workability in wire connection.

An environmental test device disclosed here includes: a test chamber having an opening and including a test space defined in the test chamber; a placement surface located in the test chamber such that a specimen is placed; and a panel located in the test chamber such that terminals electrically connected to the specimen are located, wherein the panel rotates about a rotation axis between a test position at which the specimen is tested and a work position at which work is performed on the terminals to thereby change a relative positional relationship between the panel and the placement surface.

The environmental test device is capable of enhancing workability in wire connection.

### BRIEF DESCRIPTION OF THE DRAWINGS

FIG. 1 is a schematic front view of an environmental test device

FIG. 2 is a schematic view of the environmental test device in a test.

FIG. 3 is a plan view of a panel.

FIG. 4 is an illustration for describing rotation of the panel.

FIG. 5 is a front view of a test chamber with a door open.

FIG. 6 is a cross-sectional view taken along line VI-VI in FIG. 3.

FIG. 7 is a view of the panel at a test position when seen from the left.

FIG. 8 is a front view of the panel at the test position.

FIG. 9 is a view of the panel at a work position when seen from the left.

FIG. 10 is a view of the panel at the work position when seen from the above.

### DETAILED DESCRIPTION

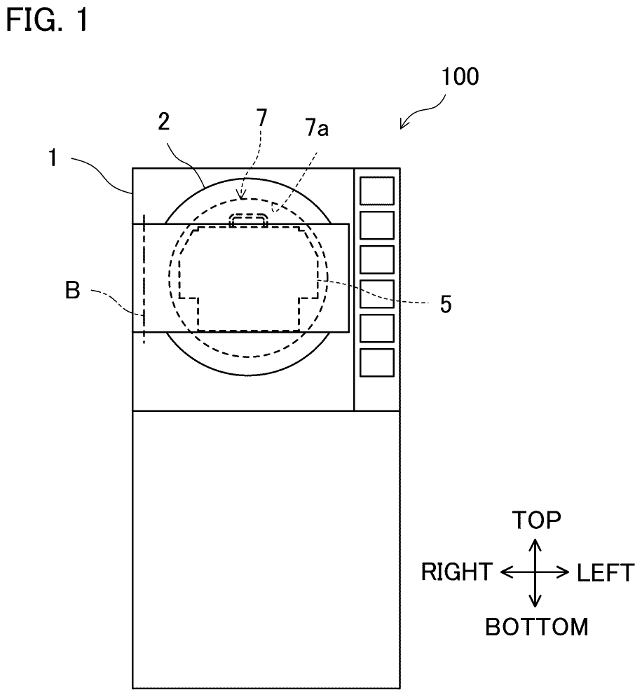

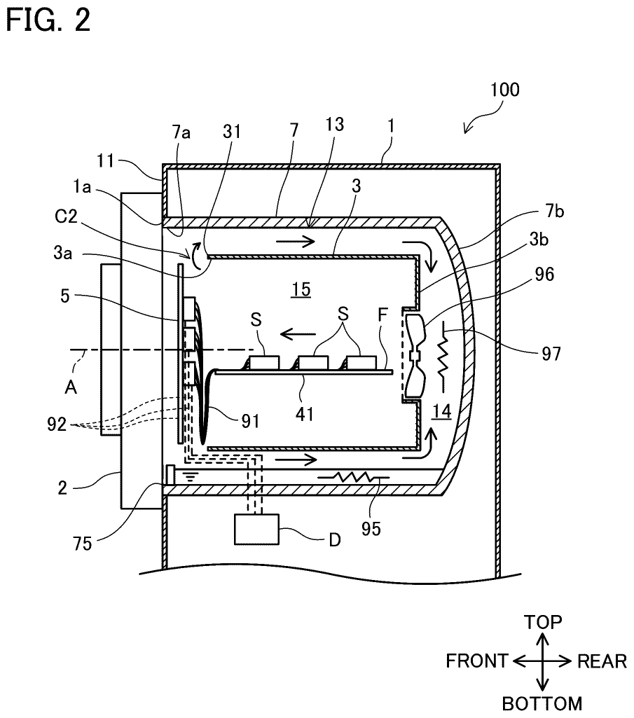

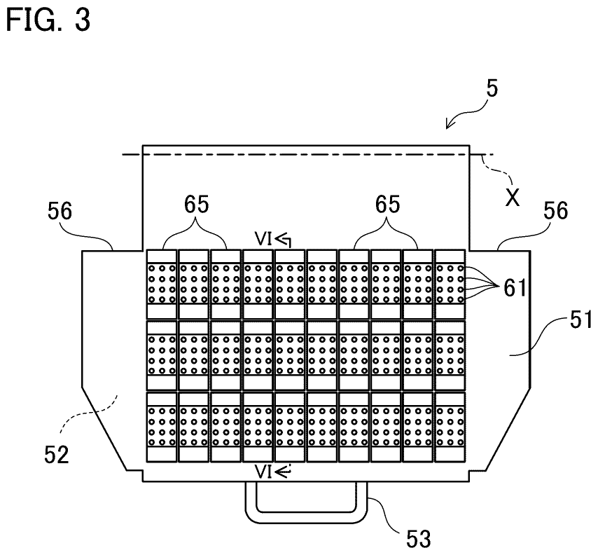

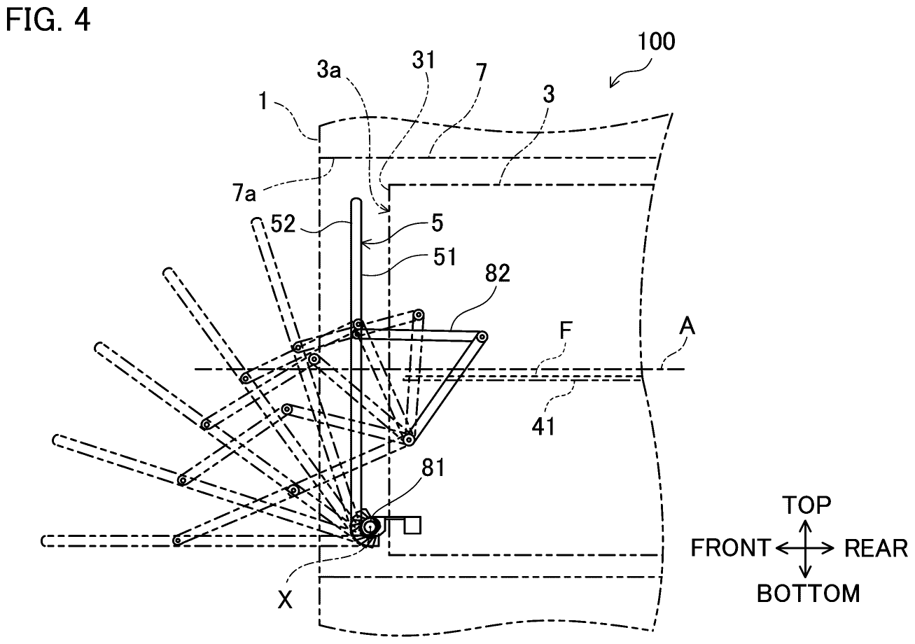

An exemplary embodiment will be described in detail hereinafter with reference to the drawings. FIG. 1 is a schematic front view of an environmental test device 100. FIG. 2 is a schematic view of the environmental test device 100 in a test. FIG. 3 is a plan view of a panel 5. FIG. 4 is an illustration for describing rotation of the panel 5.

As illustrated in FIGS. 1 and 2, the environmental test device 100 includes a test chamber 7 having an opening 7a, a placement surface F located in the test chamber 7 such that a specimen S is placed, and the panel 5 located in the test chamber 7. The environmental test device 100 may further include a specimen stage 41. The specimen stage 41 is a stage on which the specimen S is placed. The specimen stage 41 has the placement surface F. As illustrated in FIG. 3, terminals 61 electrically connected to the specimen S are located on the panel 5. As illustrated in FIG. 4, the panel 5 rotates about a rotation axis X between a test position and a work position to thereby change a relative positional relationship between the panel 5 and the placement surface F. For example, the relative positional relationship is an angle of the panel 5 with respect to the placement surface F.

The panel 5 switches between the test position and the work position by rotating about the rotation axis X. The test position is a position of the panel 5 at which the specimen S is tested. At the test position, the panel 5 is located in the test chamber 7.

The work position is a position of the panel 5 at which work is performed on the terminals 61. For example, the work at the work position is the work of connecting first wires 91 (see FIG. 2) extending from the specimen S to the terminals 61. At the work position, the panel 5 may be partially located (i.e., may partially protrude) outside the test chamber 7 through the opening 7a of the test chamber 7

The environmental test device 100 produces a test environment and tests the specimen S under the test environment. For example, the environmental test device 100 tests the specimen S by simulating an environment such as temperature, humidity, and pressure. The environmental test device 100 may be a highly accelerated stress test device. The highly accelerated stress test device is also referred to as a highly accelerated stress test (HAST) chamber. The environmental test device 100 performs a test simulating an environment including mainly temperature, humidity, and pressure. The specimen S is, for example, an electric component or an electronic component.

In this disclosure, a configuration of the environmental test device 100 will be described based on directions of the environmental test device 100. Specifically, “front” refers to the front of the environmental test device 100 in the front-rear direction, and “rear” refers to the rear of the environmental test device 100 in the front-rear direction. “Left” refers to the left of the environmental test device 100 when seeing forward from the rear, “right” refers to the right of the environmental test device 100 when seeing forward from the rear. “Upper” refers to the upper side of the environmental test device 100, and “lower” refers to the lower side of the environmental test device 100.

As illustrated in FIG. 2, a test space 13 is defined in the test chamber 7. That is, the test space 13 is a space on the inner side of the test chamber 7. For example, the test chamber 7 is a pressure vessel. The opening 7a of the test chamber 7 serves as an inlet/outlet of the specimen S to the test space 13. The opening 7a of the test chamber 7 is open forward. That is, the test chamber 7 is oriented such that the opening 7a of the test chamber 7 is open forward of the environmental test device 100. For example, the opening 7a of the test chamber 7 is substantially circular. An axis A of opening 7a of the test chamber 7 extends substantially in the front-rear direction. Hereinafter, the direction of the axis A will be referred to simply as an “axial direction,” and a radial direction about the axis A will be referred to simply as a “radial direction.” The shape of the opening 7a of the test chamber 7 is not limited to circular, and may be polygonal or oval. An end of the test chamber 7 on the side opposite to the side of the opening 7a of the test chamber 7 has a bottom 7b. That is, the test chamber 7 is a bottomed cylinder. For example, the test chamber 7 is substantially cylindrical, but is not limited to cylindrical and may be square cylindrical.

The environmental test device 100 may further include a door 2 that opens and closes the opening 7a of the test chamber 7. For example, the door 2 is located at the front side of the test chamber 7 to cover the opening 7a of the test chamber 7. A gasket for enhancing hermeticity may be located on at least one of a peripheral portion of the opening 7a of the test chamber 7 or the door 2. The door 2 hermetically seals the test space 13 by closing the opening 7a of the test chamber 7.

For example, the door 2 is a single-swing door. The door 2 may be attached to a casing 1 described later via a hinge to be rotatable about a rotation axis B (see FIG. 1) extending in the top-bottom direction. For example, the rotation axis B of the door 2 is located on the right side of the opening 7a of the test chamber 7, as illustrated in FIG. 1.

As illustrated in FIG. 2, the environmental test device 100 may further include an inner chamber 3 located inside the test chamber 7. The inner chamber 3 includes an opening 3a that allows inside and outside of the inner chamber 3 to communicate with each other. An opening edge 31 defining the opening 3a of the inner chamber 3 and an opening edge 75 defining the opening 7a of the test chamber 7 are arranged in the axial direction. The inner chamber 3 is located such that the opening 3a of the inner chamber 3 is located inside the test chamber 7 relative to the opening 7a of the test chamber 7, that is, rearward of the opening 7a of the test chamber 7. For example, the axis of the opening 3a of the inner chamber 3 is substantially parallel to the axis A of the opening 7a of the test chamber 7. That is, the axis of the opening 3a of the inner chamber 3 extends substantially in the front-rear direction. An end portion of the inner chamber 3 on the side opposite to the side of the opening 3a has a bottom 3b. That is, the inner chamber 3 is a bottomed cylinder. For example, the inner chamber 3 is substantially cylindrical, but is not limited to cylindrical and may be square cylindrical. A housing space 15 that houses the specimen S is defined in the inner chamber 3. The test space 13 includes the housing space 15.

The environmental test device 100 may further include the casing 1 located outside the test chamber 7. The casing 1 houses the test chamber 7. For example, the casing 1 is a substantially rectangular parallelepiped. The casing 1 may have an opening 1a in a front wall 11. The position of the opening 1a in the front-rear direction may substantially coincide with the position of the opening 7a of the test chamber 7 in the front-rear direction. The door 2 may open and close the opening 1a of the casing 1 as well as opening and closing the opening 7a of the test chamber 7. The shape and other properties of the casing 1 are not particularly limited as long as the casing 1 can house the test chamber 7.

The inner chamber 3 is located inside the test chamber 7. The outer surface of the inner chamber 3 is separated from the inner surface of the test chamber 7 in the entire circumference. The bottom 3b of the inner chamber 3 is separated from the bottom 7b of the test chamber 7. That is, a space 14 is defined between the inner chamber 3 and the test chamber 7. The test space 13 described above includes the space 14. The opening 3a of the inner chamber 3 is located inside the test chamber 7 relative to the opening 7a of the test chamber 7, that is, rearward of the opening 7a of the test chamber 7 in the axial direction. The opening edge 31 of the inner chamber 3 is separated from the door 2 in the closed state. That is, the opening edge 31 of the inner chamber 3 is located inside the test chamber 7 relative to the door 2 in the closed state, that is, rearward of the door 2 in the closed state.

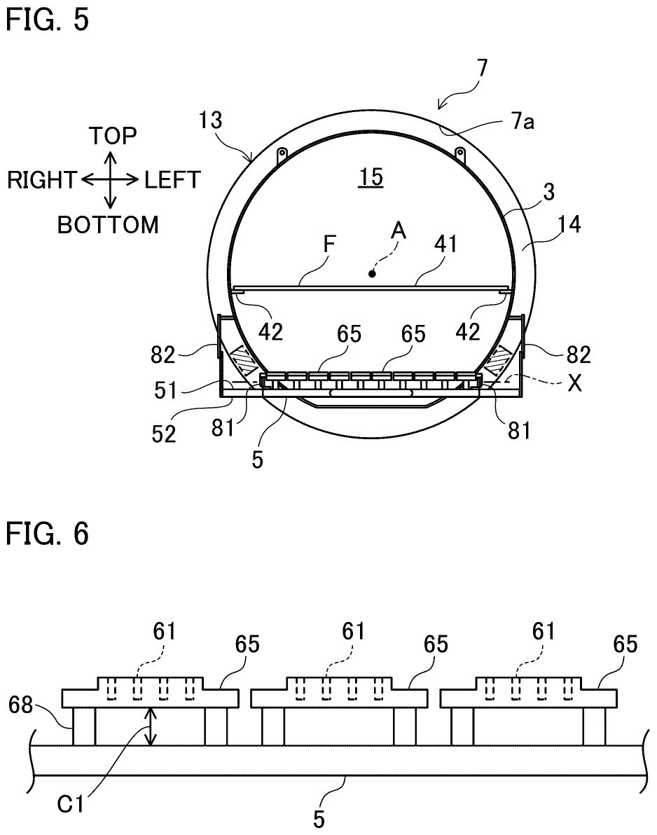

FIG. 5 is a front view of the test chamber 7 with the door 2 open. In FIG. 5, the panel 5 is located at the work position. The specimen stage 41 is housed in the inner chamber 3. That is, the specimen stage 41 is located inside the inner chamber 3 in the radial direction. For example, the specimen stage 41 is supported by the inner chamber 3. Specifically, the specimen stage 41 is supported by a stage support 42 attached to the inner surface of the inner chamber 3. For example, the specimen stage 41 has a plate shape. The specimen stage 41 is also referred to as a shelf. The specimen stage 41 is made of, for example, a wire mesh. The specimen stage 41 may be located in the inner chamber 3 while expanding substantially horizontally. In this example, the placement surface F is the upper surface of the specimen stage 41 supported by the stage support 42. A sample S (see FIG. 2) is placed on the placement surface F. The specimen stage 41 supports the specimen S from below.

As illustrated in FIGS. 2 and 3, the terminals 61 located on the panel 5 are electrically connected to the specimen S via the first wires 91. The first wires 91 extend from the specimen S. The terminals 61 on the panel 5 may be connected to an external device D via second wires 92. The external device D applies a test voltage, a signal, or the like to the specimen S, for example. The terminals 61 on the panel 5 relay the specimen S and the external device D. That is, the specimen S receive the test voltage, a signal, or the like from the external device D through the second wires 92, the terminals 61, and the first wires 91. The second wires 92 are housed in tubes made of, for example, perfluoroalkoxy alkane (PFA). The second wires 92 are an example of wires.

As illustrated in FIG. 2, the environmental test device 100 produces a test environment in the test chamber 7. An air conditioning chamber may be present in the test chamber 7. For example, the air conditioning chamber is located in the space 14 between the inner chamber 3 and the test chamber 7. A heater 97 for gas (hereinafter referred to as a gas heater 97) may be located in a rear portion of the space 14, that is, a rear portion of the test chamber 7 and between the bottom 3b of the inner chamber 3 and the bottom 7b of the test chamber 7. The gas heater 97 heats gas in the space 14. In this configuration, the test chamber 13 may be heated. A humidifying water heater 95 is located in a lower portion of the space 14, that is, in a lower portion of the internal space of the test chamber 7 and outside the inner chamber 3. In the lower portion of the space 14, water is stored, and the humidifying water heater 95 is immersed in this water. The humidifying water heater 95 heats and vaporizes water. Accordingly, heated steam is generated in the lower portion of the space 14. In this manner, the test space 13 is heated and humidified. That is, the environmental test device 100 is a single-chamber highly accelerated stress test device including a space in which gas is heated, a steam generation space in which steam is generated, and the housing space 15, in the test chamber 7.

A temperature sensor and a humidity sensor may be located in the test chamber 7. In this case, the temperature and the humidity in the test chamber 7 may be controlled based on the measured temperature and humidity.

In the environmental test device 100, a fan 96 may be located near the bottom 3b of the inner chamber 3. The fan 96 pumps gas outside the inner chamber 3 into the inner chamber 3. The fan 96 rotates to thereby causes the gas to circulate in the housing space 15 and the space 14. Specifically, in the closed state of the door 2, a test space 13 is defined as a closed space by the test chamber 7 and the door 2 in the environmental test device 100. Since the opening edge 31 of the inner chamber 3 is separated from the door 2, the housing space 15 inside the inner chamber 3 and the space 14 outside the inner chamber 3 communicate with each other through the opening 3a of the inner chamber 3. The housing space 15 inside the inner chamber 3 and the space 14 outside the inner chamber 3 also communicate with each other through the fan 96 at the bottom 3b. When the fan 96 rotates, as illustrated by the arrow in FIG. 2, gas flows from the bottom 3b toward the opening 3a of the inner chamber 3, that is, from the rear toward the front, in the inner chamber 3. The gas flowing in the inner chamber 3 flows from the opening 3a of the inner chamber 3 into the space 14 between the test chamber 7 and the inner chamber 3. In the space 14, the gas flows toward the bottom 3b and the bottom 7b, that is, from the front toward the rear. The gas that has reached the space between the bottom 3b and the bottom 7b is introduced into the inner chamber 3 by the fan 96. In this manner, the gas circulates between the housing space 15 and the space 14. Steam generated in the space 14 circulates between the housing space 15 and the space 14 along with the flow of the gas. Accordingly, the temperature, humidity, and pressure of the test space 13 are managed. Examples of the gas include air, nitrogen, and steam. The inner chamber 3 defines a gas flow path during the test and functions as a partition between the housing space 15 and the space 14.

In the environmental test device 100, the temperature, humidity, and pressure of the test space 13 are controlled in the test. A test voltage is applied to the specimen S from the external device D. Reliability and other properties of the specimen S are evaluated under such conditions.

Next, the panel 5 will be described in detail.

As illustrated in FIG. 3, the panel 5 has a plate shape. The panel 5 includes a first surface 51 and a second surface 52 on the opposite side of the first surface 51. The terminals 61 are located on the first surface 51. The terminals 61 are arranged in the in-plane direction of the first surface 51. For example, the terminals 61 are arranged in columns and rows on the panel 5. A handle 53 may be attached to the edge of the panel 5 on the side opposite to the rotation axis X. A user grips the handle 53 and rotates the panel 5 about the rotation axis X.

For example, terminal blocks 65 may be arranged on the panel 5. Each of the terminal blocks 65 may include terminals 61. The terminal blocks 65 are arranged in columns and rows on the panel 5. Consequently, the terminals 61 are arranged in columns and rows on the panel 5. In the example illustrated in FIGS. 3, 30 terminal blocks 65 are arranged on the panel 5. Each terminal block 65 includes 12 terminals 61. As a result, 360 terminals 61 are arranged on the panel 5.

To each terminal 61, the corresponding second wire 92 (see FIG. 2) is electrically connected. That is, the second wires 92 extend from each of the terminal blocks 65. The terminals 61 are connected to the second wires 92. That is, the terminals 61 are connected to the external device D via the second wires 92. The terminals 61 are connected to the first wires 1 (see FIG. 2). That is, the terminals 61 are connected to the specimen S via the first wires 91. In this example, each terminal 61 is a hole into which one end of the corresponding first wire 91 is inserted.

FIG. 6 is a cross-sectional view taken along line VI-VI in FIG. 3. The terminal blocks 65 each including the terminals 61 may be attached to the panel 5 via spacers 68 such that a clearance C1 is defined between the terminal blocks 65 and the panel 5. For example, each spacer 68 has a columnar shape extending in a direction perpendicular to the panel 5. One end of the spacer 68 is attached to the panel 5, and the other end of the spacer 68 is attached to the terminal block 65. In this manner, the terminal blocks 65 are attached to the panel 5 via the spacers 68. The spacers 68 may be made of an insulator. For example, the spacers 68 are made of a resin.

The second wires 92 (see FIG. 2) are located in the clearance C1. The second wires 92 are connected to the terminals 61 and extend into the space 14 between the test chamber 7 and the inner chamber 3 through the clearance C1. As illustrated in FIG. 2, the second wires 92 penetrate through the test chamber 7 and extend to the outside of the test chamber 7. The second wires 92 are electrically connected to the external device D outside the test chamber 7.

As illustrated in FIG. 4, the rotation axis X is located in the test chamber 7. For example, the rotation axis X is located between the door 2 in the closed state and the opening edge 31 of the inner chamber 3 in the test chamber 7.

The panel 5 at the test position may intersect the axis A of the opening 7a of the test chamber 7. For example, the panel 5 at the test position is approximately orthogonal to the axis A. The panel 5 at the work position may not intersect the axis A of the opening 7a of the test chamber 7. For example, the panel 5 at the work position may be substantially parallel to the axis A.

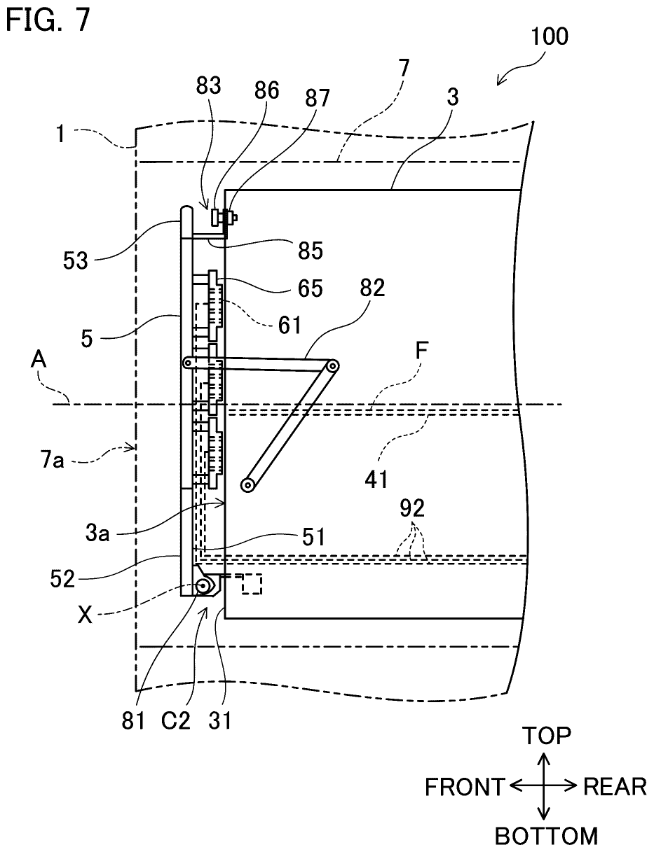

FIG. 7 is a view of the panel 5 at the test position when seen from the left. At the test position, a clearance C2 may be defined between the inner chamber 3 and the panel 5. Specifically, the clearance C2 is defined between the panel 5 at the test position and the opening edge 31 of the inner chamber 3. For example, in the test chamber 7, the panel 5 at the test position is located outside the inner chamber 3 in the direction of the axis of the opening 3a. That is, the clearance C2 in the front-rear direction is defined between the inner chamber 3 and the panel 5.

For example, the first surface 51 of the panel 5, that is, the surface on which the terminals 61 are arranged, faces inward in the inner chamber 3, that is, toward the bottom 3b (see FIG. 2), at the test position. The first surface 51 may generally face in the direction of the axis A at the test position.

As illustrated in FIG. 4, the panel 5 at the work position may be located outside the inner chamber 3. That is, at the work position, the panel 5 is also located outside the inner chamber 3 in the direction of the axis of the opening 3a. At the work position, the door 2 may be open, and a portion of the panel 5 may be located outside the test chamber 7 through the opening 7a of the test chamber 7. For example, the first surface 51 generally faces in the radial direction about the axis A at the work position.

As illustrated in FIG. 7, the panel 5 may be attached to the inner chamber 3 to be rotatable about the rotation axis X near the opening 3a of the inner chamber 3. The environmental test device 100 may further include hinges 81 that rotate the panel 5 about the rotation axis X. The hinges 81 are individually attached to the inner chamber 3 and the panel 5. The panel 5 is rotatably attached to the inner chamber 3 via the hinges 81. The rotation axis of the hinges 81 is the rotation axis X. For example, the environmental test device 100 may include a pair of hinges 81. The hinges 81 as a pair are arranged in the direction of the rotation axis X.

The environmental test device 100 may further include a stay 82 that supports the panel 5 at the work position. The stay 82 is attached to the inner chamber 3. For example, the stay 82 includes two arms that are rotatably coupled to each other. One of the arms is rotatably attached to the inner chamber 3. The other arm is rotatably attached to the panel 5. The rotation axis of each arm is substantially parallel to the rotation axis X.

As illustrated in FIG. 4, the two arms of the stay 82 bend and stretch in accordance with the state of the panel 5. When the panel 2 is at the test position, the two arms of the stay 82 are in a bent state. As the panel 5 displaces from the test position to the work position, the angle formed by the two arms of the stay 82 increases. When the panel 5 is in the work position, the two arms of the stay 82 are extended in a straight line. The stay 82 restricts rotation of the panel 5 by having the two arms extend in a straight line. That is, the stay 82 supports panel 5 at the work position when the two arms are extended.

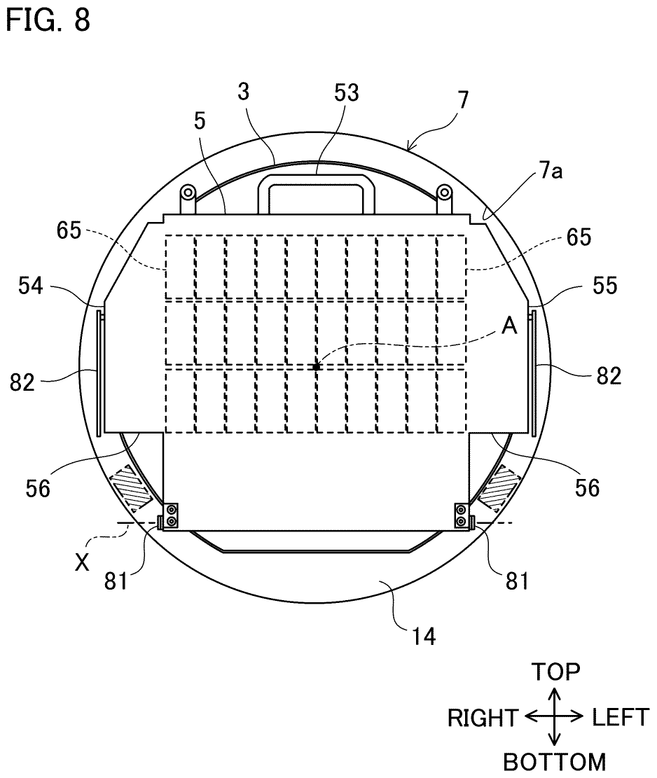

FIG. 8 is a front view of the panel 5 at the test position. The stay 82 is located radially outward of the inner chamber 3 and inward of the opening 7a of the test chamber 7 when seen in the axial direction. At the test position, at least a portion of the bent stay 82 is housed in the space 14 between the test chamber 7 and the inner chamber 3.

The environmental test device 100 may include a pair of stays 82. In the panel 5, a portion to which one of the stays 82 is coupled and a portion to which the other stay 82 is coupled are arranged in the direction of the rotation axis X at positions at approximately the same distance from the rotation axis X. For example, one of the hinges 81 and one of the stays 82 are located on a first side portion 54 of the panel 5. The other hinge 81 and the other stay 82 are arranged on a second side potion 55 of the panel 5 that is a side portion on the side opposite to the first side portion 54 in the direction of the rotation axis X.

For example, the panel 5 has notches 56 that are recessed from the outside to the inside in a plan view. The panel 5 may include two notches 56. In the state where the panel 5 is at the test position, each of the notches 56 may be located between the stay 82 and the hinge 81 when seen in the axial direction. Specifically, one of the notches 56 may be located between a portion to which the hinge 81 is coupled and a portion to which the stay 82 is coupled, in the first side portion 54 of the panel 5. The other notch 56 may be located between a portion to which the hinge 81 is coupled and a portion to which the stay 82 is coupled, in the second side portion 55 of the panel 5.

In the state where the panel 5 is at the test position, each notch 56 may be recessed to the inside of the inner chamber 3 when seen in the axial direction. In this case, the inner chamber 3 is partially visible from the panel 5 when seen in the axial direction, between the stay 82 and the hinge 81.

When the panel 5 is at the test position, the second wires 92 (see FIG. 2) may extend into the space 14 between the test chamber 7 and the inner chamber 3 from a position between the stay 82 and the hinge 81 when seen in the axial direction. For example, the second wires 92 extend into the space 14 between the test chamber 7 and the inner chamber 3 from the positions of the notches 56. The second wires 92 are divided into two and extend into the space 14 between the test chamber 7 and the inner chamber 3 from the positions of the two notches 56. In FIGS. 5 and 8, the entry positions of the second wires 92 into the space 14 are hatched.

The panel 5 at the test position may be fixed in the test chamber 7. For example, as illustrated FIG. 7, the environmental test device 100 may further include a fixture 83 that secures the panel 5 at the test position. The fixture 83 may fix the panel 5 to the inner chamber 3.

For example, the fixture 83 includes a bracket 85 attached to the panel 5, a nut 87 attached to the inner chamber 3, and a screw 86 that is screwed into the nut 87. The bracket 85 has a through hole into which the screw 86 is inserted. The screw 86 inserted into the through hole of the bracket 85 is screwed to the nut 87, thereby fixing the panel 5 at the test position to the inner chamber 3.

For example, the rotation axis X extends substantially horizontally (specifically, in the left-right direction) as illustrated in FIG. 8. The rotation axis X may be located below the axis A of the opening 7a of the test chamber 7. For example, the height position of the rotation axis X is lower than the height position of the placement surface F. In this example, as illustrated in FIG. 7, the placement surface F is the upper surface of the specimen stage 41, and thus, the height position of the specimen stage 41 is higher than the height position of the rotation axis X. The rotation axis X may be located in a relatively lower portion of the opening 3a of the inner chamber 3. The height position of a portion of the stay 82 coupled to the inner chamber 3 may be higher than the height position of the rotation shaft X.

At the test position, the panel 5 may be oriented in a standing state in the vertical direction in the test chamber 7. For example, the panel 5 at the test position is oriented in a standing state substantially perpendicular to the placement surface F in the test chamber 7. When the panel 5 displaces from the test position to the work position, the panel 5 rotates about the rotation axis X such that the end portion of the panel 5 far from the rotation axis X rotates downward, as illustrated in FIG. 4. That is, the panel 5 at the test position rotates downward to reach the work position.

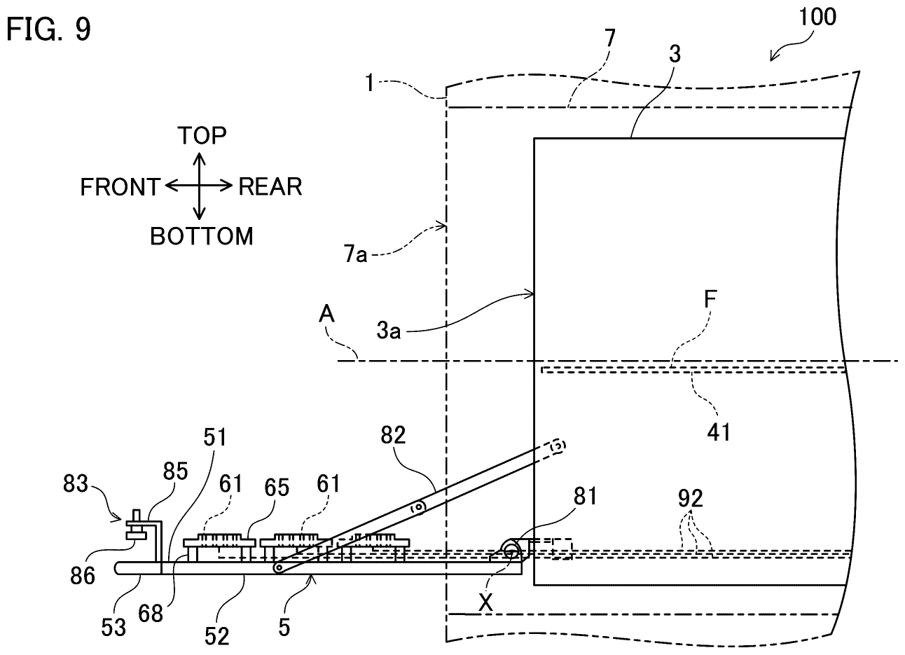

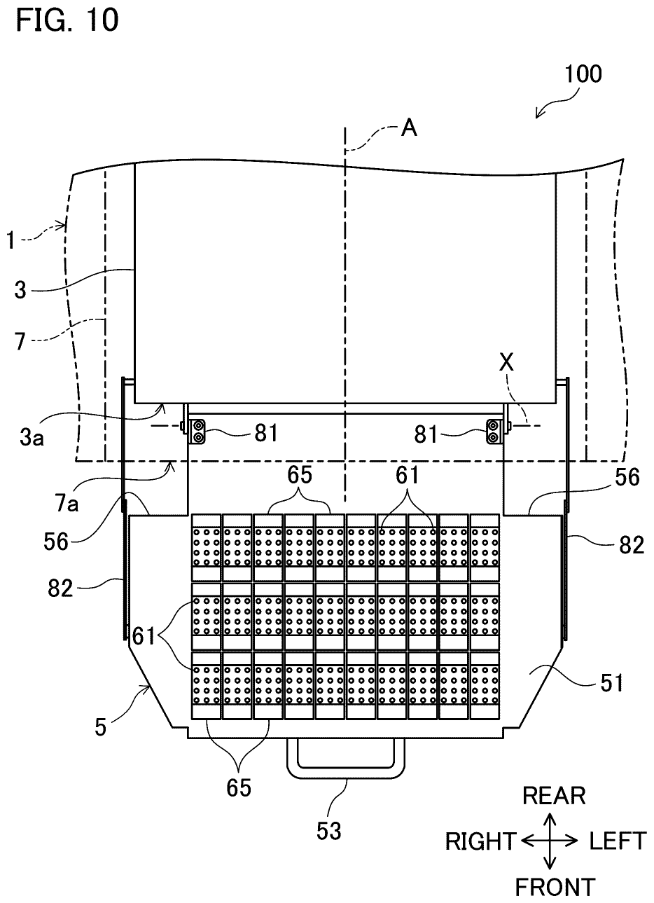

FIG. 9 is a view of the panel 5 at the work position when seen from the left. FIG. 10 is a view of the panel 5 at the work position when seen from above. At the work position, the first surface 51 of the panel 5, that is, the surface on which the terminals 61 are arranged faces upward. In this example, at the work position, the first surface 51 faces generally upward in the vertical direction. That is, the panel 5 at the work position is oriented generally horizontally.

The panel 5 at the work position is located outside the opening 3a of the inner chamber 3. At the work position, at least a portion of the terminals 61 are located outside the test chamber 7 through the opening 7a of the test chamber 7. At the work position, all the terminals 61 may be located outside the test chamber 7 through the opening 7a of the test chamber 7. Similarly, at least a portion of the terminals 61 may be located outside the casing 1 through the opening 1a (see FIG. 2) of the casing 1. At the work position, all the terminals 61 may be located outside the casing 1 through the opening 1a of the casing 1. At the work position, the second wires 92 (see FIG. 2) also extend into the space 14 between the test chamber 7 and the inner chamber 3 from a position between the stay 82 and the hinge 81 when seen in the axial direction in the state where the panel 5 is at the test position, similarly to the panel 5 in the test position.

Next, an example of a method of using the environmental test device 100 will be described. First, a user opens the door 2, grips the handle 53 of the panel 5 at the test position, and tilts the panel 5 toward the user. Accordingly, the panel 5 rotates about the rotation axis X to reach the work position. The user mounts the specimen stage 41 on which the specimen S is placed, on the stage support 42. Alternatively, in the case of mounting the specimen stage 41 on which no specimen S is placed on the stage support 42, the user places the specimen S on the specimen stage 41 mounted on the stage support 42. The first wires 91 are connected to the specimen S beforehand. Thereafter, the user connects the first wires 91 to the corresponding terminals 61. At this time, since the first surface 51 of the panel 5 on which the terminals 61 are placed faces upward, the user can perform work while clearly checking the terminals 61 from above. When connection of the first wires 91 is completed, the user grips the handle 53 of the panel 5 at the work position and lifts the panel 5. Accordingly, the panel 5 rotates about the rotation axis X to reach the test position. The user fixes the panel 5 to the inner chamber 3 using the fixture 83. The user closes the door 2 and starts a test.

In the test, the environmental test device 100 actuates the humidifying water heater 95, the gas heater 97, and the fan 96. The humidifying water heater 95 generates steam in the space 14. The generated steam flows into the inner chamber 3 from the bottom 3b of the inner chamber 3 by an airflow generated by the fan 96. The steam flows in the inner chamber 3 toward the opening 3a of the inner chamber 3. The panel 5 is located near the opening 3a of the inner chamber 3, and the clearance C2 is defined between the panel 5 and the opening edge 31 of the inner chamber 3. Accordingly, the steam flows into the space 14 between the test chamber 7 and the inner chamber 3 through the clearance C2. The steam that has flowed into the space 14 flows toward the bottom 7b of the test chamber 7. Thus, the steam circulates in the test chamber 7. The gas heater 97 further heats the steam generated in the space 14. This enables a test under high temperature conditions, as well as a test under saturation vapor pressure conditions (100% rh) and unsaturated vapor pressure conditions (e.g., 85% rh), which are conditions for reliability tests.

The environmental test device 100 controls the temperature, humidity, and pressure of the test space 13. The specimen S is exposed to an environment produced by the environmental test device 100, and a test voltage, a signal, or the like is applied to the specimen S from the external device D. Reliability and other properties of the specimen S is evaluated under determined conditions.

In the environmental test device 100, the panel 5 rotates about the rotation axis X between the test position and the work position to thereby change a relative positional relationship between the panel 5 and the placement surface F. Accordingly, the terminals 61 can be moved to a relatively free positions independently of the placement surface F. In wire connection, the user rotates the panel 5 to thereby displace the panel 5 to the work position at which the terminals 61 are easily accessible. Consequently, workability in wire connection is enhanced.

In particular, in this example, at the work position of the panel 5, the first surface 51 of the panel 5 on which the terminals 61 are arranged faces upward. The user can easily check the terminals 61 from above. That is, visibility of the terminals 61 is enhanced. In addition, the terminals 61 face upward, allowing access to the terminals 61 with the wire ends facing downward. The wires hang down due to gravity, and thus, the wires can easily reach the target terminal 61 by accessing to the terminals 61 with the wire ends facing downward. Consequently, workability in wire connection is further enhanced.

At the work position of the panel 5, at least a portion of the terminals 61 is located outside the test chamber 7 through from the opening 7a of the test chamber 7. This allows the user to perform wire connection work outside the test chamber 7. Consequently, workability in wire connection is further enhanced.

The terminals 61 are located on the panel 5. Since a space in which the terminals 61 can be placed on the panel 5 is relatively large, the number of terminals 61 can be easily increased.

The environmental test device 100 performs a test at high humidity, and thus, may cause dew condensation in the test chamber 7. At the test position, the panel 5 is oriented in a standing state in the direction perpendicular to the placement surface F in the test chamber 7, and thus, even if water adheres to the panel 5, water is likely to fall along the panel 5. This reduces short circuits between the terminals 61.

The height position of the placement surface F is higher than the height position of the rotation axis X. Accordingly, in using the specimen stage 41, for example, the panel 5 at the work position can be easily placed at a position lower than the specimen stage 41. At the work position, the specimen stage 41 is inserted into and removed from the test chamber 7 in some cases. By placing the panel 5 at the work position at a relatively low position, interference between the specimen stage 41 and the panel 5 can be reduced, making handling of the specimen stage 41 easier.

The terminals 61 are attached to the panel 5 via the spacers 68 such that the clearance C1 is defined between the terminals 61 and the panel 5. Accordingly, the second wires 92 can be arranged through the clearance C1. Assuming that the second wires 92 are drawn out to the second surface 52 of the panel 5 through the panel 5, the work will become complicated during replacement of the terminals 61 and the second wires 92. By arranging both the terminals 61 and the second wires 92 on the first surface 51 of the panel 5, workability of replacement work is enhanced.

The inner chamber 3 is located inside the test chamber 7, and the opening edge 31 defining the opening 3a of the inner chamber 3 and the opening edge 75 defining the opening 7a of the test chamber 7 are arranged in the axial direction. The panel 5 is attached to the inner chamber 3 to be rotatable about the rotation axis X near the opening 3a of the inner chamber 3 or the opening 7a of the test chamber 7. This allows the panel 5 at the test position to be placed in the test chamber 7.

In the state where the panel 5 is at the test position, the clearance C2 is defined between the inner chamber 3 and the panel 5. This enables gas to pass through the clearance C2, allowing circulation of the gas between the inside and outside of the inner chamber 3.

The panel 5 at the test position and the work position is located outside the opening 3a of the inner chamber 3. Accordingly, a space for placing the specimen S in the housing space 15 is obtained. In addition, at the test position, at least a portion of the stay 82 is housed in the space 14 between the test chamber 7 and the inner chamber 3. This further ensures a space for placing the specimen S in the housing space 15.

The panel 5 has the notches 56. The notches 56 are shaped such that the test space 13 in the inner chamber 3 is partially visible when seen in the axial direction in the state where the panel 5 is at the test position. The second wires 92 extend into the space 14 between the test chamber 7 and the inner chamber 3 from the positions of the notches 56. The second wires 92 may be bent in a portion where the second wires 92 enter the space 14 from the panel 5. The portions where bending occurs in the second wires 92 may greatly expand depending on elasticity of the second wires 92. With the notches 56 described above located in the panel 5, even if the second wires 92 are bent to enter the space 14 between the test chamber 7 and the inner chamber 3, interference between the second wires 92 and the panel 5 is less likely to occur. Consequently, excessive stress on the second wires 92 can be prevented or reduced.

The second wires 92 extend into the space 14 between the test chamber 7 and the inner chamber 3 from a position between the stay 82 and the hinge 81 when seen in the axial direction. This enables the second wires 92 to enter the space 14 from the position near the hinge 81. Consequently, when the panel 5 rotates from the test position to the work position, pulling of the second wires 92 by the panel 5 is suppressed, reducing a load on the second wires 92.

The second wires 92 are housed in tubes made of, for example, PFA. Accordingly, breakage of the second wires 92 during rotation of the panel 5 is suppressed.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The environmental test device may be a double-chamber highly accelerated stress test device in which a steam generation space and a housing space are separated. The double chamber type may not include the inner chamber 3, or the steam generation space where steam is generated may be used as a steam generation chamber separately from the test chamber 7. The environmental test device is not limited to the highly accelerated stress test device as long as the environmental test device can test a specimen S by simulating environments such as temperature and humidity. It is sufficient for the environmental test device to control at least one of temperature, humidity, or pressure.

The environmental test device may not include the inner chamber 3. The environmental test device may not include the specimen stage 41. In this case, the specimen S may be directly placed on the inner surface of the inner chamber 3 or may be placed on a specimen stage placed on the inner surface of the inner chamber 3. In the case where the specimen S is directly placed on the inner surface of the inner chamber 3, the placement surface F is the inner surface of the inner chamber 3. In the case where the specimen S is placed on the specimen stage, the placement surface F is the upper surface of the specimen stage.

The door 2 of the environmental test device may not be a hinged door. For example, the door may be a sliding door that slides in the front-rear directions, or a drawer type. In such cases, the panel 5 may be attached to the back side of the door (i.e., rear surface of the door) in, for example, a standing state. Further, in such cases, the door may rotate about the rotation axis extending in the horizontal direction, for example. The panel 5 may alternately switch between the test position and the work position in cooperation with rotation of the door.

The test chamber 7 is not limited to a pressure vessel. The shape of the test chamber 7 is not limited. For example, the shape of the test chamber 7 may be simply a rectangular parallelepiped, for example.

The casing 1 may be omitted. In this case, the test chamber 7 may be supported by a frame. The door 2 may be attached to the test chamber 7 to open and close the opening 7a of the test chamber 7.

The height position of the placement surface F may be lower than the height position of the rotation axis X. The environmental test device 100 may include two or more specimen stages 41. In this case, the height position of the lowermost specimen stage 41 may be higher than the height position of the rotation axis X.

The shape of the panel 5 is not limited. For example, the panel 5 may not include the notches 56. The panel 5 at the test position and the work position may not be located outside the opening 3a of the inner chamber 3. Specifically, the panel 5 may be attached to the inner surface of the inner chamber 3 or the inner surface of the test chamber 7. In this case, in the state where the panel 5 is at the test position, the panel 5 is located inside the opening 3a of the inner chamber 3, and in the state where the panel 5 is at the work position, at least a portion of the panel 5 may be located inside the opening 3a of the inner chamber 3. In this case, a clearance in the radial direction may be defined between the inner surface of the inner chamber 3 and the outer circumference edge of the panel 5. During the test, it is sufficient for gas to pass through this clearance and circulate in the test space 13.

The rotation axis X may extend substantially in the vertical direction. That is, the panel 5 may rotate to open rightward or leftward. When the panel 5 rotates rightward, at the work position of the panel 5, the first surface 51 of the panel 5 on which the terminals 61 are arranged may face leftward. When the panel 5 rotates leftward, at the work position of the panel 5, the first surface 51 of the panel 5 on which the terminals 61 are arranged may face to rightward.

At the test position, the panel 5 may not be oriented in a standing state perpendicular to the placement surface F in the test chamber 7. That is, at the test position, the panel 5 may be tilted with respect to the vertical direction in the test chamber 7. At the work position, the panel 5 may be tilted with respect to the horizontal plane. For example, at the work position, the panel 5 may be tilted with respect to the horizontal plane such that the front end position of the panel 5 is lower than the rear end position of the panel 5.

The number of the terminals 61 and arrangement of the terminals 61 with respect to the panel 5 are not limited.

In the state where the panel 5 is at the work position, the terminals 61 may be arranged inside the test chamber 7, or some of the terminals 61 may be arranged inside the test chamber 7.

The terminals 61 may not be attached to the panel 5 via the spacers 68. For example, the terminal blocks 65 with the terminals 61 may be directly attached to the panel 5. In this case, the second wires 92 may penetrate the panel 5 and extend into the space 14 between the test chamber 7 and the inner chamber 3 along the side of the second surface 52 of the panel 5.

At the test position, the stay 82 may be housed in the inner chamber 3. At the test position, a portion of the stay 82 may be housed in the space 14 between the test chamber 7 and the inner chamber 3, or the entire stay 82 may be housed in the space 14. A member that supports the panel 5 at the work position is not limited to the stay 82. For example, the hinge 81 or a cylinder may support the panel 5 at the work position. Specifically, the hinge 81 may be a hinge that can temporarily hold the panel 5 at a certain angle.

The second wires 92 may extend into the space 14 between the test chamber 7 and the inner chamber 3 from a position different from the positions of the notches 56 of the panel 5. The second wires 92 may not extend into the space 14 between the test chamber 7 and the inner chamber 3 from the position between the stay 82 and the hinge 81 when seen in the axial direction.

### ASPECTS

The embodiment described above are a specific example of the following aspects.

### Aspect 1

An environmental test device 100 includes: a test chamber 7 having an opening 7a and including a test space 13 defined in the test chamber 7; a placement surface F located in the test chamber 7 such that a specimen S is placed; and a panel 5 located in the test chamber 7 such that terminals 61 electrically connected to the specimen S are located, the panel 5 rotates about a rotation axis X between a test position at which the specimen S is tested and a work position at which work is performed on the terminals 61 to thereby change a relative positional relationship between the panel 5 and the placement surface F.

In this configuration, the panel 5 rotates about the rotation axis X between the test position and the work position to thereby change the relative positional relationship between the panel 5 and the placement surface F, and thus, the terminals 61 can be moved to relatively free positions independently of the placement surface F. In wire connection, the user rotates the panel 5 to thereby displace the panel 5 to the work position at which the terminals 61 are easily accessible. Consequently, workability in wire connection is enhanced.

### Aspect 2

In environmental test device 100 of Aspect 1, at the work position, a surface of the panel 5 on which the terminals 61 are located face upward.

In this configuration, the user can easily check the terminals 61 from above. That is, visibility of the terminals 61 is enhanced. In addition, the terminals 61 face upward, allowing access to the terminals 61 with the wire ends facing downward. The wires hang down due to gravity, and thus, the wires can easily reach the target terminal 61 by accessing to the terminals 61 with the wire ends facing downward. Consequently, workability in wire connection is further enhanced.

### Aspect 3

In the environmental test device 100 of Aspect 1 or 2, at the work position, at least a portion of the terminals 61 is located outside the test chamber 7 through the opening 7a.

With this configuration, the user can perform wire connection work outside the test chamber 7. Consequently, workability in wire connection is further enhanced.

### Aspect 4

In the environmental test device 100 of any one of Aspects 1 to 3, at the test position, the panel 5 is oriented in a standing state with respect to the placement surface F in the test chamber 7.

The environmental test device 100 performs a test at high humidity, and thus, may cause dew condensation in the test chamber 7. In the configuration, even if water adheres to the panel 5, water is likely to fall along the panel 5. This reduces short circuits between the terminals 61.

### Aspect 5

In the environmental test device 100 of any one of Aspects 1 to 4, the rotation axis X of the panel 5 extends in a horizontal direction, and a height position of the placement surface F is higher than a height position of the rotation axis X.

In this configuration, in using the specimen stage 41, for example, the panel 5 at the work position can be easily placed at a position lower than the specimen stage 41. At the work position, the specimen stage 41 is inserted into and removed from the test chamber 7 in some cases. By placing the panel 5 at the work position at a relatively low position, interference between the specimen stage 41 or the specimen S and the panel 5 can be reduced, making handling of the specimen stage 41 and the specimens S easier.

### Aspect 6

The environmental test device 100 of any one of Aspects 1 to 5 further includes an inner chamber 3 located inside the test chamber 7, a space 14 is defined between the test chamber 7 and the inner chamber 3, the inner chamber 3 includes an opening 3a that allows inside and outside of the inner chamber 3 to communicate with each other, and an opening edge 31 defining the opening 3a of the inner chamber 3 and an opening edge 75 defining the opening 7a of the test chamber 7 are arranged in a direction of an axis A of the opening 7a of the test chamber 7.

In this configuration, the panel 5 at the test position can be placed in the test chamber 7.

### Aspect 7

In the environmental test device 100 of any one of Aspects 1 to 6, at the test position, a clearance C2 is defined between the inner chamber 3 and the panel 5.

This configuration enables gas to pass through the clearance C2, allowing circulation of the gas between the inside and outside of the inner chamber 3.

### Aspect 8

The environmental test device 100 of any one of Aspects 1 to 7 further includes a stay 82 attached to the inner chamber 3 and supporting the panel 5 at the work position, and at the test position, at least a portion of the stay 82 is housed in the space 14 between the test chamber 7 and the inner chamber 3.

This configuration obtains a space for placing a specimen S in the space (housing space 15) inside the inner chamber 3.

### Aspect 9

In the environmental test device 100 of any one of Aspects 1 to 8, the terminals 61 is attached to the panel 5 via a spacer 68 such that a clearance C1 is defined between the terminals 61 and the panel 5.

In this configuration, for example, the wires (second wires 91) that connect the device (external device D) located outside the environmental test device 100 and the terminals 61 can be arranged in the clearance C1. In a configuration in which the wires are drawn out from the panel 5 through the panel 5, the work will become complicated during replacement of the terminals 61 and the wires. By arranging both the terminals 61 and the wires on one surface (the first surface 51) of the panel 5, workability of replacement work is enhanced.

### Aspect 10

In the environmental test device 100 of any one of Aspects 1 to 9, the test chamber 7 is a pressure vessel.

This configuration enables a test simulating a high-pressure environment.

### Aspect 11

In the environmental test device 100 of any one of Aspects 1 to 100, the panel 5 at the test position and at the work position is located outside the opening 3a of the inner chamber 3.

This configuration further ensures a space for placing a specimen S in the space (housing space 15) inside the inner chamber 3.

### Aspect 12

The environmental test device 100 of any one of Aspects 1 to 11 further includes wires (second wires 92) connected to the terminals 61 and extending in the space 14 between the test chamber 7 and the inner chamber 3, the panel 5 includes a notch 56 that is recessed from the outside to the inside in a plan view, and at the test position, the notch 56 is recessed to the inside of the inner chamber 3 and the wires extends into the space 14 from a position of the notch 56 when seen in a direction of an axis of the inner chamber 3.

The wires may be bent in a portion that enters the space 14 from the panel 5. The portions where bending occurs in the wires may greatly expand depending on elasticity of the wires. With the notch 56 located in the panel 5, even if the wires are bent to enter the space 14 between the test chamber 7 and the inner chamber 3, interference between the wires and the panel 5 is less likely to occur. Consequently, excessive stress on the wires can be prevented or reduced.

### Aspect 13

The environmental test device 100 of any one of Aspects a to 12 further includes; wires (second wires 92) connected to the terminals 61 and extending in the space 14 between the test chamber 7 and the inner chamber 3; a stay 82 attached to the inner chamber 3 and supporting the panel 5 at the work position; and a hinge 81 that rotates the panel 5 about the rotation axis X of the panel 5, and the wires extends into the space 14 from a position between the stay 82 and the hinge 81 when seen in a direction of an axis of the inner chamber 3.

This configuration enables the wires to enter the space 14 from a position near the hinge 81. Consequently, when the panel 5 rotates from the test position to the work position, pulling of the wires by the panel 5 is suppressed, reducing a load on the wires.

### Aspect 14

The environmental test device 100 of any one of Aspects 1 to 13 further includes a door 2 that opens and closes the opening 7a of the test chamber 7.

In this configuration, the test space 13 can be hermetically sealed.

What is claimed is:

1. The environmental test device comprising:
a test chamber having an opening and including a test space defined in the test chamber;
a placement surface located in the test chamber such that a specimen is placed; and
a panel located in the test chamber such that terminals electrically connected to the specimen are located, wherein
the panel rotates about a rotation axis between a test position at which the specimen is tested and a work position at which work is performed on the terminals to thereby change a relative positional relationship between the panel and the placement surface.

2. The environmental test device according to claim 1, wherein
at the work position, a surface of the panel on which the terminals are located face upward.

3. The environmental test device according to claim 1, wherein
at the work position, at least a portion of the terminals is located outside the test chamber through the opening.

4. The environmental test device according to claim 1, wherein
at the test position, the panel is oriented in a standing state with respect to the placement surface in the test chamber.

5. The environmental test device according to claim 1, wherein
the rotation axis of the panel extends in a horizontal direction, and
a height position of the placement surface is higher than a height position of the rotation axis.

6. The environmental test device according to claim 1, further comprising
an inner chamber located inside the test chamber, wherein
a space is defined between the test chamber and the inner chamber,
the inner chamber includes an opening that allows inside and outside of the inner chamber to communicate with each other, and
an opening edge defining the opening of the inner chamber and an opening edge defining the opening of the test chamber are arranged in a direction of an axis of the opening of the test chamber.

7. The environmental test device according to claim 6, wherein
at the test position, a clearance is defined between the inner chamber and the panel.

8. The environmental test device according to claim 6, further comprising
a stay attached to the inner chamber and supporting the panel at the work position, wherein
at the test position, at least a portion of the stay is housed in the space between the test chamber and the inner chamber.
